(19) United States
(12) Patent Application Publication
(10) Pub. No.: US 2003/0145706 A1
(43) Pub. Date: Aug. 7, 2003

(54) Guide for power tool

(76) Inventor: Bobby Jordan, Smiths, AL (US)

Correspondence Address: BRADLEY ARANT ROSE & WHITE, LLP, INTELLECTUAL PROPERTY DEPARTMENT-NWJ, 1819 FIFTH AVENUE NORTH, BIRMINGHAM, AL, 35203-2104, US

(21) Appl. No.: 10/068,667

(22) Filed: Feb. 6, 2002

(51) Int. Cl. B23B 5/18

(52) U.S. Cl. 83/468.4; 83/574

(57) ABSTRACT

A lightweight, portable guide assembly for use with a power tool such as a hand-held circular saw is described having a platform, a front, a rear support and a bottom plate secured to the platform and a removable base secured to the assembly through an attachment means. The platform contains a pair of adjustable parallel guides for receiving the power tool and a blade gap allowing the power tool to contact a workpiece. The assembly is designed such that the blade of the circular saw contacts and penetrates the base without damage to the saw or the assembly, obviating the need for adjustment of the assembly before use and allowing for simplicity in design and construction of the guide assembly.

### FIELD OF INVENTION

The present disclosure relates generally to a guide assembly for use with a power tool, and specifically, to a lightweight, portable guide assembly for such use.

### BACKGROUND

At any construction site, it is required that a variety of materials, commonly wood, be cut to any number of dimensions. In many cases, sections of consistent length must be produced. For example, many construction projects require a large number of short sections of wood to serves as frames, braces, bridging, blocking and lookouts. Ideally, these short sections are produced with 90 angles on both their ends. Therefore, it is desirable to produce these sections as quickly, easily and accurately as possible. In many cases, these cuts are produced by large, dedicated devices where the saw is permanently attached to a table or other platform, such as a chop saw. These units allow the wood or other material to be cut to the desired length or angle by controlling/guiding the motion of the saw blade and providing a stable platform to support the wood or other material to be cut. However, these units are expensive and are not easy to transport from job to job.

Small, handheld portable saws could be used in many for many of these applications if a device was available to accurately and efficiently control/guide the cuts made by the portable saw. A number of prior devices have been made to address this issue. However, none have provided a lightweight, portable guide for a hand-held circular saw that is simple and inexpensive to manufacture and that can be quickly installed for use at any construction site. The present disclosure provides such a solution.

### BRIEF SUMMARY OF THE INVENTION

In view of the shortcomings of prior art devices, the present disclosure describes a lightweight, portable guide assembly for a hand-held circular saw or similar power tool. This device allows an individual to accurately and reproducibly cut wood or other materials without the need for a dedicated saw unit. The present disclosure describes an assembly having a platform secured to a front support, a rear support and a bottom plate. The platform, front support, rear support and bottom plate define a cavity to receive a workpiece to be cut. The width of the cavity is defined by the distance between the front and rear supports, and can be varied as desired. However, it is sufficient for most purposes if the cavity is about 10-12 inches wide. The platform incorporates 2 parallel guides to receive a hand-held circular saw or other unit. It is preferred that the width between the guides be adjustable so the guides can receive a variety of hand-held circular saws.

The guide assembly is secured to a removable base on the job site prior to use by an attachment means. In a preferred embodiment, a pair of set screws extend through the front support to firmly contact the removable base and secure the base against the rear support. The base can be of any material, but it is preferred the base be a section of wood close to the width of the cavity, such as a section of 2×10 lumber. The base provides a support for the workpiece, allowing the workpiece to be cut. The depth of the cavity, which is determined by the height of the front and rear supports and the placement of the attachment means, is such that the blade of the hand-held circular saw will slightly penetrate and cut the base, allowing the workpiece to be cut completely.

The platform has an elongated slit, or blade gap, to receive the saw blade and allow it to contact and cut the workpiece. The platform and the blade gap extend horizontally beyond the front and rear supports. The front and/or rear supports contain an essentially U-shaped channel in register with the blade gap to allow the saw blade to travel the entire distance of the cavity. In addition, the guide assembly may further comprise a measuring device to provide a simple means to cut pieces of a desired length. A stop may also be movably attached to the measuring device, allowing the user to slide the workpiece against the stop to quickly produce multiple sections of the same length.

### BRIEF DESCRIPTION OF THE DRAWINGS

FIG. 1 is a perspective view of one embodiment of the guide assembly of the present disclosure;

FIG. 2 is a side view of the guide assembly shown in FIG. 1;

FIG. 3 is a top view of the guide assembly shown in FIG. 1;

FIG. 4 is a frontal view of the guide assembly shown in FIG. 1; and

FIG. 5 is a side view of an alternate embodiment of the guide assembly of the present disclosure.

### DETAILED DESCRIPTION

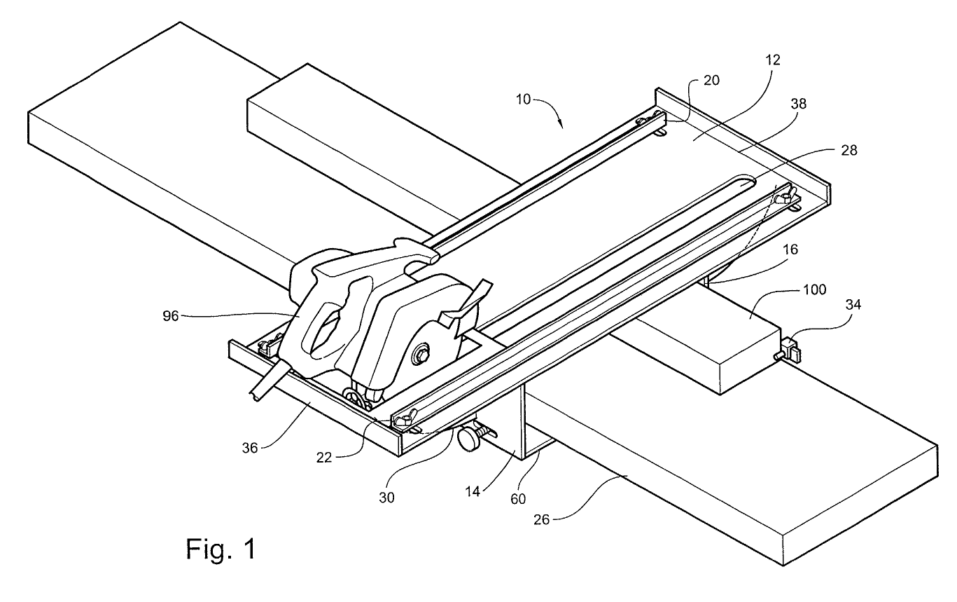

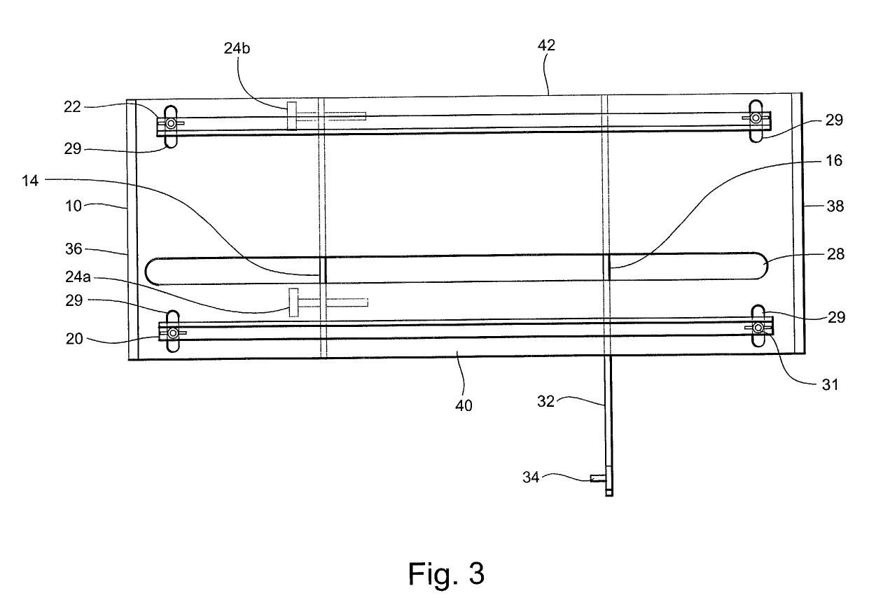

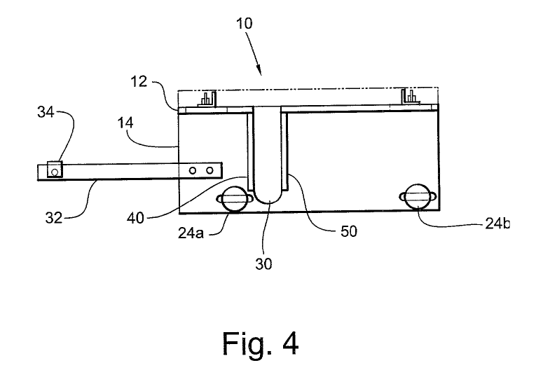

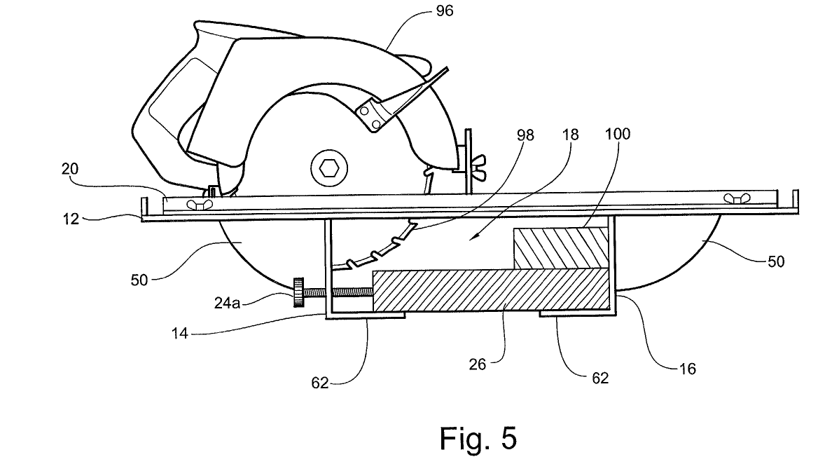

The present disclosure describes a lightweight, portable guide assembly for use with a power tool, such as a handheld circular saw. Referring now to FIGS. 1-5, wherein like reference numbers designate corresponding elements, one embodiment of the assembly 10 comprises a platform 12, a front support 14, a rear support 16 and a bottom plate 60 which define a cavity 18 to receive a workpiece 100. The front support and rear support are secured to the platform 12 by any convenient means such as welding, nuts and bolts, brackets or screws, or a combination of any of these methods. In an alternate embodiment, the assembly 10 may eliminate the bottom plate 60 and incorporate a flange 62 (FIG. 5) to support the removable base 26. Alternatively, both the bottom 60 and flange 62 may be omitted.

The platform 12 is planar and in the general shape of a rectangle, the platform 12 having a front end 36, a rear end 38 and two side ends 40 and 42. Other shapes for the platform 12 are possible. Secured to the platform 12 are a pair of parallel guides 20 and 22. The guides 20 and 22 are essentially L-shaped channels comprising a vertical section and a horizontal section joined together at a generally 90 degree angle. The guides 20 and 22 receive the power tool, shown as a hand-held power saw 96 in FIGS. 1, 2 and 5. It is preferred that at least one of the parallel guides 20 or 22 is adjustable. In the embodiment shown in FIGS. 1-5, both guides 20 and 22 can be adjusted. In this embodiment, guides 20 and 22 are movably secured to platform 12 through interaction with guide slots 29. The guide slots 29 are elongated slots in platform 12 that are perpendicular to the side ends 40 and 42. The guides 20 and 22 have openings in their horizontal sections in register with the guide slots 29. The guides 20 and 22 are moveably secured to the platform by a securing means, such as a wingnut, passing through the guide slots 29 and openings in guides 20 and 22. The length of the guide slots 29 is sufficient to allow the guides 20 and 22 to expand or contract a sufficient distance to receive a variety of power tools. It is preferred that there be two guide slots 29 per guide, however, additional or fewer guide slots 29 may be incorporated if desired. In the event only one of the two guides 20 or 22 is adjustable, the number of guide slots 29 per guide will be decreased and the length of the guide slots 29 will be increased. In the event one of the guides 20 or 22 is not adjustable, the guide will be permanently secured to the platform 12 by any convenient means, such as welding, rivets, nuts and bolts or screws.

The platform 12 further comprises an elongated slit, or blade gap, 28 to allow the blade 98 of the circular saw 96 to traverse the cavity 18 and to contact the workpiece 100. The blade gap 28 is parallel to the side ends 40 and 42. At least one of the front 14 or the rear 16 supports contains a channel 30 in register with the blade gap 28 so that the saw blade 98 can completely traverse the cavity 18 and cut the workpiece 100. It is preferred that both the front support 14 and the rear support 16 contain channels 30 and the channel be essentially U-shaped. The width of the blade gap 28 and channels 30 is sufficient to receive the saw blade 98 without contacting the platform 12 or the front 14 and rear 16 supports. It is also preferred that the platform 12 and blade gap 28 extend beyond the front 14 and rear 16 supports so that the saw blade 98 can pass completely through the cavity 18. In addition, the platform 12 may contain raised edges along the front 36, rear 38, and side 40 and 42 ends if desired.

The assembly 12 is secured to a removable base 26 prior to use by an attachment means. The base 26 serves to support the workpiece 100. The base 26 can be of a variety of materials, but it is preferred that the base 26 be a section of lumber such as a section of 2×10. In FIGS. 1-5 the attachment means is shown as set screws, although other means such as clamps may be used. The set screws are located on the front support 14 and penetrate the front support 14 through complementary, threaded receiving holes. In the embodiments illustrated two set screws 24A and 24B are shown located in the front support 14, however, a greater or lesser number may be used if desired. Additionally, the set screws or other attachment means may be located on the rear support 16, or both the front 14 and rear 16 supports. In the embodiment illustrated, the set screws 24A and 24B extend through the front support 14 and contact the base 26, forcing the base 26 against the rear support 16 as the set screws 24A and 24B are tightened. The set screws may be of any configuration desired, so long as the function of securing the assembly 10 to the base 26 is achieved. The base 26 may also be partially supported by the bottom 60 secured to the front 14 and rear 16 supports, if bottom 60 is incorporated into the assembly 10. Alternatively, the front 14 and rear 16 supports may incorporate a flange 62 extending perpendicularly a sufficient distance from the front 14 and rear 16 supports into cavity 18 to aid in supporting the base 26. In addition, both bottom 60 and flange 62 may be omitted if desired and the base 26 supported solely by the attachment means.

The width of cavity 18 is determined by the distance between the front 14 and rear 16 supports. The depth of cavity 18 is determined by the height of the front 14 and rear 16 supports and the placement of the attachment means. Each of these dimensions can be varied as desired by varying the configuration of the corresponding elements. In the embodiment illustrated, the width of the cavity 18 is designed to receive a 2×10 section of lumber as the removable base 26. Therefore, the distance between the front 14 and rear supports is designed to be slightly greater than the width of the 2×10 section of lumber. The depth of the cavity 18 in the embodiment illustrated is such that the saw blade 98 will penetrate the surface of the base 26, so that the workpiece 100 will be completely severed.

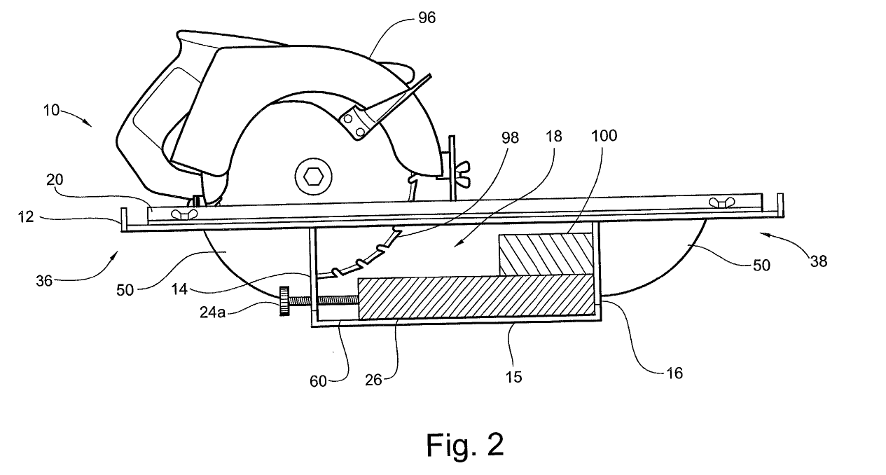

The assembly 10 also comprises protective guards 50 extending from the front 14 and/or rear 16 supports on both sides of the at least one channel 30. The guards 50 function to prevent injury from the blade 98 as it extends through channels 30 beyond the front 14 and rear 16 supports. In the embodiment shown in FIG. 2, two sets of protective guards 50 are shown since both the front 14 and rear 16 supports incorporate channels 30. If only one of the front or rear supports incorporates a channel 30, then only one set of protective guards 50 need be used.

The assembly 10 may also comprise a measuring device 32 secured to the front 14 and/or rear 16 supports. The measuring device 32 may be removable or fixed and functions to allow the user to quickly determine the length of the sections to be cut. In addition, a moveably stop 34 may be incorporated into the measuring device 32. The stop 34 may be placed at a location on the measuring device 32 to allow the user to quickly and accurately produce sections of the workpiece of the desired length. Subsequent sections can be made to this exact length by sliding the workpiece 100 to be cut against the stop 34 and making a cut. In this manner, the user can quickly and accurately place the workpiece 100 along the measuring device 32 to produce a section of the proper length.

In operation of the embodiment illustrated, the assembly 10 is simple to operate and can be installed at any given work site quickly. The assembly 10 is installed by securing an appropriate base 26 to the assembly 10 through the action of the attachment means, illustrated in FIGS. 1-5 as set screws 24A and 24B. Once the base is in position, the set screws 24A and 24B are tightened forcing the base against the rear support 16 and securing the base 26 to the assembly 10. The base 26 is supported by the bottom plate 60 or the flange 62, or if neither are incorporated into the assembly 10, by the set screws 24A and 24B. The base 26 should be constructed of a material that will allow the saw blade 98 to penetrate the base 26 without damage to the saw blade 98, as it is required that the saw blade penetrate the base 26 to completely sever the workpiece 100. The base 26 is preferably a 2×10 section of lumber, as discussed above. Once the base 26 is secured to the assembly 10, the assembly 10 may be placed on a flat surface for operation. If the base 26 is of sufficient length, the base 26 can be placed between two sawhorses or similar items. The assembly 10 is now ready for use.

A workpiece 100 is inserted into the cavity 18 so that it rests on base 26. The workpiece 100 is placed perpendicular to blade gap 28 so that a right angle cut is produced. The simplest way to ensure the workpiece 100 is perpendicular to the blade gap 28 is to place the workpiece 100 against either the front 14 or rear 16 supports. The user slides the workpiece 100 along the base 26 so that a section of the desired length is produced by the cut. The user may be aided by the measuring device 32 and/or stop 34 in this action. Once the workpiece 100 is at the desired location, the circular saw 96 is used to cut the workpiece 100. The saw blade 98 extends along the length of blade gap 28 and traverse the cavity to completely cut the workpiece 100. As described above, the saw blade 98 penetrates the base 26. Since the saw blade 98 will be in contact with base 26 before it begins to cut workpiece 100, a cleaner cut on workpiece 100 is produced. The process can be repeated multiple times to quickly and accurately produce sections of uniform length.

The assembly is lightweight, portable and easy to install, requiring no special equipment or materials for use. Therefore, the assembly can be used on any job site and can be easily taken from job site to job site as required. The design principles of the assembly allow it to be produced at a greatly reduced cost as compared to other devices that perform the same function. The assembly can be constructed of any material, including plastics, woods or metals, but a preferred material is aluminum because of its low cost, high strength and light weight.

Because the circular saw rest directly on the platform and the cutting of the workpiece occurs in the cavity, the guides can be mounted on the platform without the need to produce a raised guide structure as is seen in many of the prior art devices. This arrangement greatly simplifies the construction of the assembly and provides for simpler use in operation. Additionally, there is no need to produce recessed area in the bottom portion of the assembly since the assembly incorporates a base that is penetrated by the saw blade. In many prior art devices, the workpiece must be position over a recess to allow a complete cut through the workpiece. The guide assembly of the present disclosure utilizes a base that is slightly penetrated by the saw blade, allowing the workpiece to be completely cut without damage to the assembly or the saw blade. In addition, because it is not necessary to place the saw blade over a recessed area as is required in other devices, the parallel guides of the assembly are easier to adjust. Furthermore, since the base is a section of lumber, it is commonly available at any job site. Finally, the assembly can be quickly installed for use at any job site by securing the assembly to an appropriate base and placing the assembly on any flat surface, such as created by suspending the base between two sawhorses. Therefore, the assembly can be easily transported from job site to job site and does not require elaborate mounting procedures to safely secure the assembly for use.

The above discussion has described several embodiment of the assembly in detail so that the assembly and its principle of operation may be understood. The above discussion should not be interpreted to exclude additional embodiments of the assembly. With respect to the above description, it should be considered that the optimal dimensional relationships for the various parts of the assembly, including variations in size, materials, shape, form, function and manner of operation, construction and use, may be readily apparent to one of ordinary skill in the art, and all equivalent relationships to those described above and illustrated in the figures are intended to be encompassed by the present disclosure. Therefore, the foregoing is considered illustrative only, and should not be understood to limit the scope of the disclosure to the exact construction and operation discussed and illustrated.

I claim:

1. A power tool guide assembly, the assembly comprising:
a. a platform, the platform having a front end, a rear end and 2 side ends, and a blade gap parallel to the side ends, the blade gap extending from the front end to the rear end along at least a portion of the platform to receive a power tool blade;
b. a pair of parallel guides secured to the platform to receive the power tool, at least one of the guide rails incorporating an adjustment means;
c. a front support and a rear support secured to the platform, the platform, the front support and the rear support partially defining a cavity to receive a workpiece to be cut; and
d. an attachment means to secure the assembly to a removable base, the base being penetrated by the power tool blade during use of the power tool guide assembly.

2. The assembly of claim 1 where the front support and the rear support further comprise a U-shaped channel in register with the blade gap.

3. The assembly of claim 2 further comprising at least one guide slot on the platform perpendicular to the side ends and where the parallel guides are L-shaped channels, at least one parallel guide having at least one hole therein in register with the at least one guide slot to receive a securing means to allow adjustment of the at least one guide.

4. The assembly of claim 3 where each of the parallel guides have at least one hole therein in register with the at least one guide slot on the platform to receive a securing means to allow adjustment of each of the parallel guides.

5. The assembly of claim 2 where the platform and the blade gap extend beyond the front support and the rear support.

6. The assembly of claim 1 where the attachment means comprises at least one set screw extending through the front support and/or the rear support.

7. The assembly of claim 1 where the front support and the rear support are secured to the platform by a weld, nuts and bolts, brackets, screws, or a combination of any of the foregoing.

8. The assembly of claim 5 further comprising at least one protective shield, the protective shield secured to the front support and the rear support on each side of the U-shaped channel

9. The assembly of claim 1 further comprising at least one measuring device secured to the assembly, the measuring device being essentially perpendicular to the side ends.

10. The assembly of claim 9 further comprising a stop slidably mounted to the at least one measuring device.

11. The assembly of claim 1 further comprising a bottom plate secured to the front and rear support opposite the platform.

12. The assembly of claim 1 where the front support and the rear support further comprise a flange extending perpendicularly from the front and the rear support into the cavity.

13. The assembly of claim 11 where the front support and the rear support further comprise a U-shaped channel in register with the blade gap.

14. The assembly of claim 13 further comprising at least one guide slot on the platform perpendicular to the side ends and where the parallel guides are L-shaped channels, at least one parallel guide having at least one hole therein in register with the at least one guide slot to receive a securing means to allow adjustment of the at least one guide.

15. The assembly of claim 14 where each of the parallel guides have at least one hole therein in register with the at least one guide slot on the platform to receive a securing means to allow adjustment of each of the parallel guides.

16. The assembly of claim 13 where the platform and the blade gap extend beyond the front support and the rear support.

17. The assembly of claim 11 where the attachment means comprises at least one set screw extending through the front support and/or the rear support.

18. The assembly of claim 11 where the front support and the rear support are secured to the assembly by a weld, nuts and bolts, brackets, screws, or a combination of any of the foregoing.

19. The assembly of claim 16 further comprising at least one protective shield, the protective shield secured to the front support and the rear support on each side of the U-shaped channel

20. The assembly of claim 11 further comprising at least one measuring device secured to the assembly, the measuring device being essentially perpendicular to the side ends.

21. The assembly of claim 20 further comprising a stop slidably mounted to the at least one measuring device.
